(19) United States
(12) Patent Application Publication
(10) Pub. No.: US 2016/0226930 A1
(43) Pub. Date: Aug. 4, 2016

(54) METHOD AND SYSTEM FOR COMMUNICATION DEVICES

(71) Applicant: Cisco Technology, Inc., San Jose, CA (US)

(72) Inventors: Shuyi ZHANG, Shanghai (CN); Junhua MA, Shanghai (CN); XiuYing ZHANG, Shenzhen (CN); Chongni LI, Shanghai (CN)

(21) Appl. No.: 14/608,215

(22) Filed: Jan. 29, 2015

(51) Int. Cl. H04L 29/06; G06F 3/0488; G06F 3/0486; G06F 3/0484; H04W 4/16; G06F 3/0481

(52) U.S. Cl. CPC H04L 65/1093; H04W 4/16; G06F 3/04817; G06F 3/0486; G06F 3/04847; G06F 3/04883; H04L 65/403

(57) ABSTRACT

In one embodiment a user interface for a communication device is described, the user interface including a first icon representing a first communication event between a first party and a second party, and a second icon representing a second communication event between the first party and a third party, a processor to receive input signals from the first party, the signals input via the user interface, the processor, in response to the received input signals, performs one of a communication event transfer including transferring the first communication event from being between the first party and the second party to being between the second party and the third party, and a communication event merger including the creation of a merged communication event between the user, the second party, and the third party. Related methods, systems, and apparatuses are also described.

### TECHNICAL FIELD

The present disclosure generally relates to collaboration among users of touchscreen devices.

### BACKGROUND

Advances in communications technologies have challenged designers of user interfaces for communication devices, particularly in light of the increasing popularity of touch screen devices. For example, a common challenge has been to design and implement user interfaces that provide an appropriate balance of information, usability, intuitiveness, control, and functionality that promotes a quality user experience.

### BRIEF DESCRIPTION OF THE DRAWINGS

The present disclosure will be understood and appreciated more fully from the following detailed description, taken in conjunction with the drawings in which:

FIG. 1 is a simplified pictorial illustration of a user interface first embodiment of the present invention constructed and operative in accordance with a first embodiment of the present invention;

FIG. 2 is a simplified flowchart diagram of a method of operation of the embodiment of FIG. 1;

FIGS. 3A and 3B are a simplified pictorial illustration of a user interface constructed and operative in accordance with a second embodiment embodiment of the present invention;

FIG. 4 is a simplified flowchart diagram of a first method of operation of the embodiment of FIGS. 3A and 3B; and

FIG. 5 is a simplified flowchart diagram of a second method of operation of the embodiment of FIGS. 3A and 3B.

### DESCRIPTION OF EXAMPLE EMBODIMENTS

### Overview

A method, system, and apparatus are described, the method, system, and apparatus including a user interface for a communication device, the user interface including a first icon representing a first communication event between a first party and a second party, and a second icon representing a second communication event between the first party and a third party, a processor to receive input signals from the first party, the signals input via the user interface, the processor, in response to the received input signals, performs one of a communication event transfer including transferring the first communication event from being between the first party and the second party to being between the second party and the third party, and a communication event merger including the creation of a merged communication event between the user, the second party, and the third party. Related methods, systems, and apparatuses are also described.

### Exemplary Embodiments

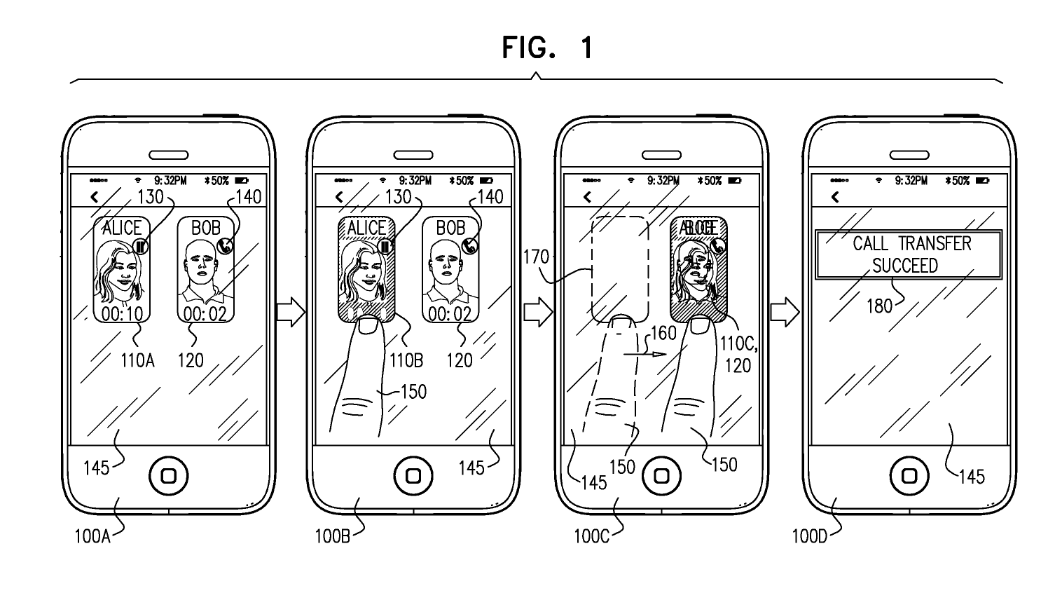

Reference is now made to FIG. 1, which is a simplified pictorial illustration of a user interface constructed and operative in accordance with a first embodiment of the present invention. A method for transferring a first communication event is depicted as an ordered sequence of events. The method for transferring the first communication event (e.g. a phone call) is depicted as being between a first party (i.e. the user of a smart phone) and a second party to being between the second party and a third party. The smart phone is shown in four views, 100A-100D, and it is appreciated that in FIG. 1, the smart phones 100A-100D are all the same smart phone at different stages of operation of transferring the communication event. The same is true of other elements depicted in the figure, such as, but not limited to first icon 110A, 110B.

In a first stage, the smart phone 100A displays two icons 110A, 120 indicating that two phone calls are in progress. The first phone call is represented by first icon 110A. Icon 110A displays an icon element 130 indicating that a phone call with Alice has been placed on hold. Similarly, second icon 120 displays an icon element 140 indicating that a second phone call with Bob is in progress. As is typical in the art, smart phone 100A-100D comprises a touch screen user interface 145.

In a second stage, a user's finger 150 is displayed indicating that the user is interacting with the touch screen user interface 145 of the smart phone 100B. The user's finger 150 is placed on the first icon 110B. At this point, the first icon 110B is depicted as being hashed, in order to indicate that the smart phone 100B touch screen user interface 145 displays the first icon 110B as highlighted.

In a third stage, the user's finger 150 is shown on the smart phone 100C as having dragged (arrow 160) the first icon 110C from its previous location 170 so as to now be superimposed on top of the second icon 120.

Finally, in a fourth stage, the user's finger 150 is removed from the smart phone 100D touch screen user interface 145. The first icon 110A-110C and the second icon 120 are no longer displayed on the touch screen user interface 145. An on-screen display 180 appears on the smart phone 100D touch screen, informing the user that “CALL TRANSFER SUCCEEDED”.

Typical implementations of the smart phone 100A-100D comprise at least one processor, one of which may be a special purpose processor operative to perform the methods for transferring calls (and/or, as will be described below, managing conference calls), according to the methods described herein. In addition, the smart phone 100A-100D comprises non-transitory processor-readable storage media (i.e. memory). The memory may store instructions, which at least one of the processors may execute, in order to perform the methods described herein. The smart phone 100A-100D also comprises the touch screen user interface 145, which is in communication with the processor. The smart phone 100A-100D further comprises typical and standard hardware and software components as are known in the art not specifically described herein, for the sake of brevity.

It is also appreciated that although the present specification speaks of a smart phone, such as the smart phone 100A-100D, the methods and systems described herein may be implemented in any appropriate device which is a communication device. Such devices might include, but not be limited to a tablet device, smartphone, desktop or portable computer, set-top box, Internet-enabled television, media center PC, or any other suitable device, such as is known in the art. Similarly, although the present description refers to manipulation by the user's finger 150 on touch screen user interface 145, other appropriate pointing methods as are known in the art (e.g., but not limited to: mice, eye tracking methods, etc.)

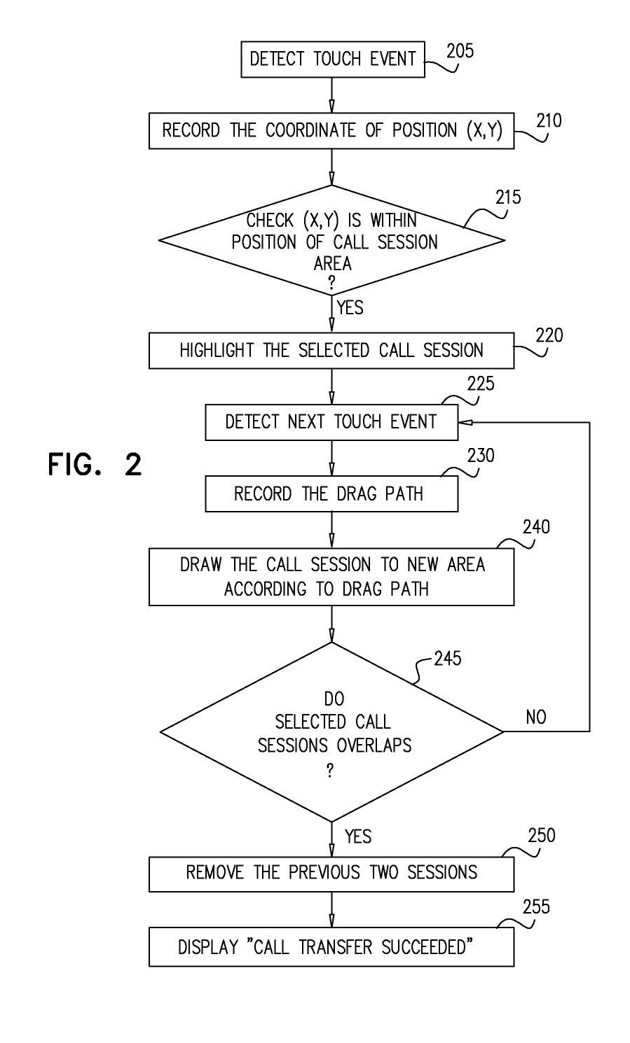

Reference is now additionally made to FIG. 2, which is a simplified flowchart diagram of a method of operation of the embodiment of FIG. 1. In step 205, a touch event is detected as having occurred on the touch screen user interface 145 of the smart phone 100A-100D. The touch screen user interface 145 relays the coordinates of (i.e.: X, Y) where the touch occurs to the processor (step 210). The processor in turn stores the coordinates in the memory. By way of example, in FIG. 1, the user's finger 150 first invokes a touch event (as in step 205) when it touches the first icon 110B on smart phone 100B. The coordinates where the user's finger 150 is resting would, in step 210, be recorded in the memory.

A check is performed by the processor to determine if the coordinates (X, Y) where the touch event was detected is within the position of the call session area, i.e. one of the icons 110B, 120 of FIG. 1 (step 215). It is appreciated that a touch event which is not detected within the position of the call session area produces no result in the context of the present embodiment (e.g., in FIG. 1, the user's finger 150 may be well below and to the right of the first icon 110B). If the touch event is determined in step 215 to be within the position of the call session area, then the selected call session is highlighted (step 220). By way of example, it was noted above that when the user's finger touches the first icon 110B, the smart phone 100B touch screen user interface 145 displays the first icon 110B as highlighted.

At this point, the touch screen user interface 145 detects a next touch event (step 225), in this case, a drag event. By way of example, in FIG. 1, the user's finger 150 is shown on the smart phone 100C as having dragged (arrow 160) the first icon 110C from its previous location to be on top of the second icon 120. In step 230 the touch screen user interface 145 relays the drag path to the processor. The processor in turn stores the drag path in the memory. It is appreciated that the drag path is an ordered list of (X,Y) coordinates through which the user's finger 150 travels in dragging the first icon 110A onto second icon 120.

A graphics processor (which may be one of the processors mentioned above) draws the first icon 110A on the portion of the touch screen to which the first icon 110A has been dragged (step 240). In FIG. 1, for example, the first icon 110A, 110B has been dragged atop the second icon 120, as it is depicted on smart phone 100C.

The processor determines if the selected call session (represented by the first icon 110A, 110B) overlaps a second call session (represented by the second icon 120) (step 245). If the processor determines that the selected call session does not overlap the second call session, then the method returns to step 225, and waits for a drag action, as described above. If, however, the processor determines that the selected call session does overlap the second call session, then the processor will remove the first and second call sessions represented by the first icon 110A-C and second icon 120 (step 250), and display the on-screen display 180, i.e., “CALL TRANSFER SUCCEEDED” or other appropriate message (step 255). It is appreciated that a sufficient partial overlap of the first icon 110A-C and second icon 120 in step 250 may be treated as a completely successful drag action. The amount of overlap which is to be treated as a completely successful drag action is typically application dependent, and may be 50% overlap, 75% overlap, or 95% overlap in particular applications, by way of example.

The phone call is transferred (e.g. to the third party—Bob) by the communication devices using telephonic techniques known in the art.

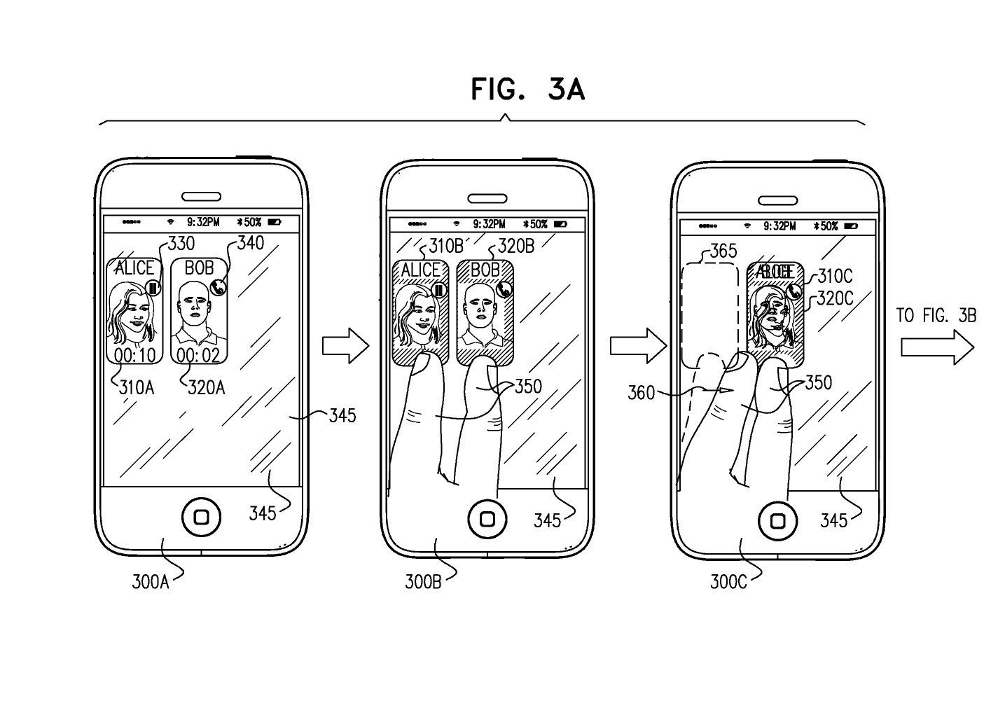

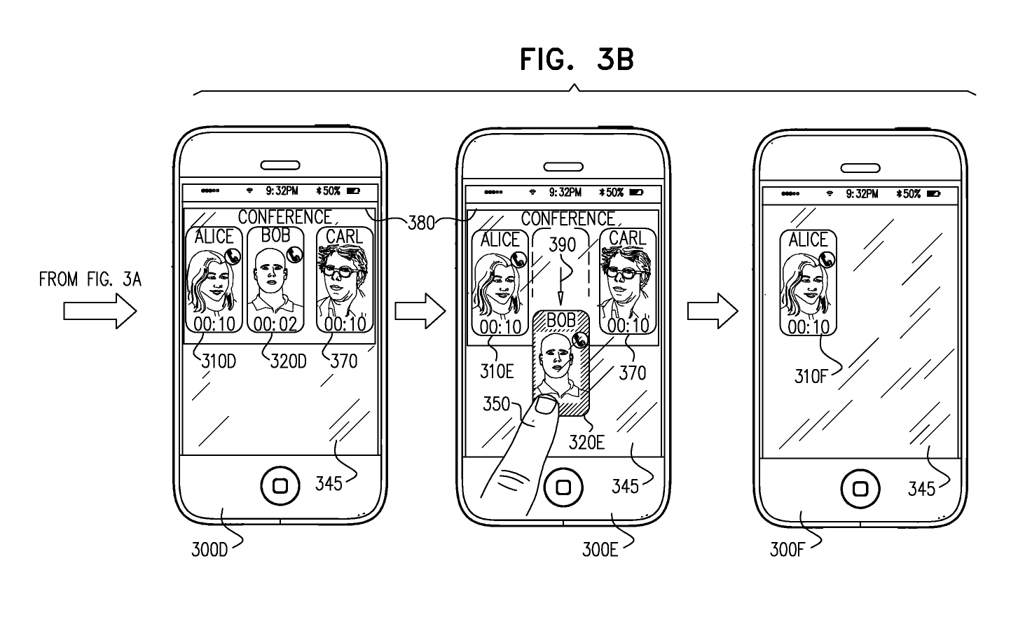

Reference is now made to FIGS. 3A and 3B, which are a simplified pictorial illustration of a user interface constructed and operative in accordance with a second embodiment embodiment of the present invention. A method of creating a merged communication event, such as a conference call, by merging individual communications events between the user of a smart phone 300A-F and at least a second and third party is depicted as an ordered sequence of events occurring on the smart phone 300A-F. As was the case with FIG. 1, it is appreciated that in FIGS. 3A and 3B, the smart phones 300A-F are all the same smart phone at different stages of the operation of merging the communication event. The same is true of other elements in the figure, such as, but not limited to the third icon 310A-F, the fourth icon 320A-E, and so forth.

In a first stage, the smart phone 300A displays two icons 310A, 320A indicating that two phone calls are in progress. The first phone call is represented by third icon 310A. Third icon 310A displays an icon element 330 indicating that a phone call with Alice has been placed on hold. Similarly, fourth icon 320A displays an icon element 340 indicating that a second phone call with Bob is in progress. As is typical in the art, smart phone 300A-300F comprises a touch screen user interface 345.

In a second stage, two of a user's fingers 350 are displayed indicating that the user is interacting with the touch screen user interface 345 of the smart phone 300B. One of the user's two fingers 350 are placed on the third icon 310B. The second one of the user's two fingers 350 are placed on the fourth icon 320B. At this point, the third icon 110B and the fourth icon 320B are depicted as being hashed, in order to indicate that the touch screen user interface 345 displays the third icon 310B and the fourth icon 320B as highlighted.

In a third stage, the user's two fingers 350 are shown on the smart phone 300C as having pinched (arrow 360) the third icon 310C from its previous location 365 so that the third icon 310C is now superimposed on top of the fourth icon 320C.

In a fourth stage, the smart phone 300D touch screen user interface 345 displays a box 380 around the third icon 310D, the fourth icon 320D, and a newly displayed fifth icon 370. The box 380 indicates that a conference call has been created by merging the two calls represented by the third icon 310D and the fourth icon 320D. The fifth icon 370 is now displayed indicating that the user (Carl) of the smart phone 300D is also a participant in the conference call which was created.

In a fifth stage, the user's finger 350 is placed on the fourth icon 320E, and the user swipes the finger 350 down (arrow 390). The fourth icon 320E is dragged out of the conference call box 380. Bob, the conference call participant represented by the fourth icon 320E is now removed from the conference call. As a result, the call is now just between Carl, the user of the smart phone 300E and Alice, represented by the third icon 310E. Accordingly, in a sixth and final stage, shown on smart phone 300F, only the third icon 310F remains, indicating a single active phone call between Carl and Alice.

It is appreciated in the above description that only three parties (Alice, Bob, and Carl, the user of the smart phone 300A-F) are depicted. However, the depiction of FIGS. 3A-B is exemplary, and persons of skill in the art will appreciate how the method depicted may be generalized to include more than three participants in the conference call.

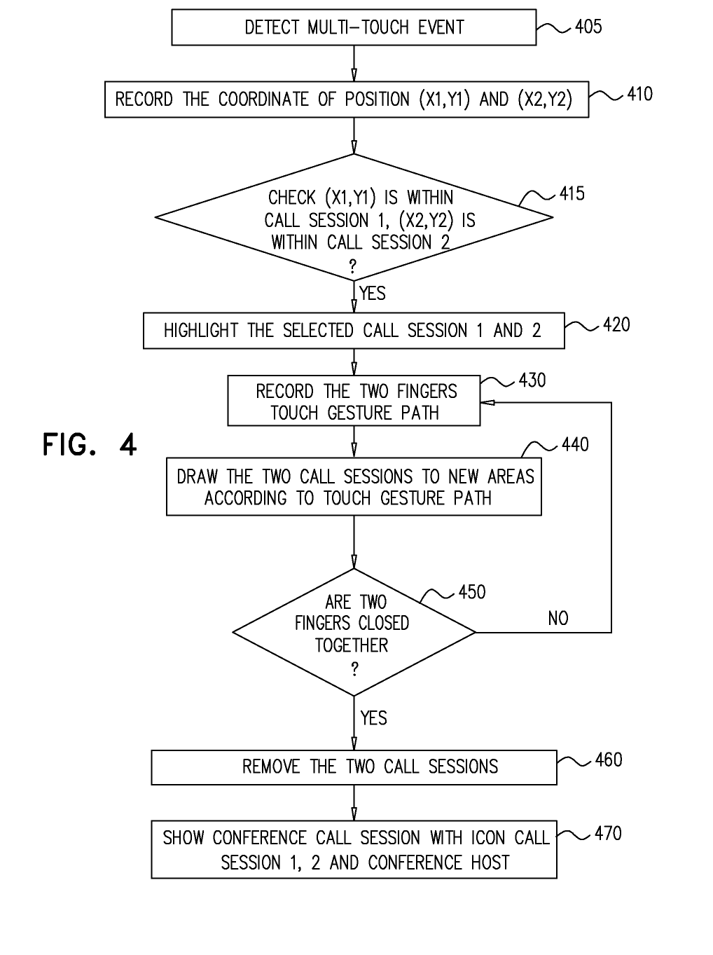

Reference is now additionally made to FIG. 4, which is a simplified flowchart diagram of a first method of operation of the embodiment of FIGS. 3A and 3B. FIG. 4 depicts the method of merging of the calls, as shown in the first four stages of FIGS. 3A-B. In step 405, a multi-touch event (such as the user placing the two fingers 350 on the touch screen user interface 345, as described above) is detected as having occurred on the touch screen user interface 345 of the smart phone 300A-300D. The touch screen user interface 345 relays the coordinates of (i.e.: X1, Y1; and X2, Y2) where the multi-touch event occurs to the processor (step 410). The processor in turn stores the coordinates in the memory.

By way of example, in FIG. 3A, the user's finger 350 first invokes a multi-touch event (as in step 405) when it touches the third icon 310B and the fourth icon 320B on smart phone 300B. The coordinates where the user's two fingers 350 are resting would be recorded in the memory in step 410.

A check is performed by the processor to determine if the coordinates (X1, Y1) where a first portion of the multi-touch event was detected is within the position of the first call session area, and to determine if the coordinates (X2, Y2) where a second portion of the multi-touch event was detected is within the position of the second call session area (step 415). It is appreciated that where only one of the two touch events of the multi-touch event is determined to be within the position of one of the call session areas, then the icon will move on the touch screen user interface 345 according to the gesture, but no conference call will result.

It is appreciated that if both portions of the multi-touch event are not detected within the position of either of the call session areas, no result in the context of the present embodiment is produced (e.g., in the second stage FIG. 3A, the user's fingers 350 may be below and to the right of the third icon 310B and the fourth icon 320B).

If the multi-touch event is determined in step 415 to be within the position of the two call session areas, then the two selected calls session are highlighted (step 420). By way of example, it was noted above that when the user's fingers touched the third icon 310B and the fourth icon 320B, the smart phone 300B touch screen user interface 345 displays the third icon 310B and the fourth icon 320B as highlighted.

In step 430 the touch screen user interface 345 relays the pinch path to the processor. The processor in turn stores the pinch path in the memory. It is appreciated that the drag path is, in fact, an ordered list of (X,Y) coordinates through which the user's two fingers 350 travel in pinching the third icon 310C onto and the fourth icon 320C.

A graphics processor (which may be one of the processors mentioned above) draws the third icon 310C and the fourth icon 320C onto the portion of the touch screen to which the third icon 310C and the fourth icon 320C have been dragged (step 440). In FIG. 3A, for example, the third icon 310C and the fourth icon 320C have been dragged together, as it is depicted on smart phone 300C. The third icon 310C and the fourth icon 320C are drawn on the portion of the touch screen according to the stored coordinates through which the pinch touch event was recorded to have occurred.

By comparing the stored coordinates at the end of the path of the pinch event (i.e. X1,Y1 and X2,Y2), using techniques known in the art, the processor determines if the user's two fingers 350 are closed together or not (step 450). If the user's two fingers 350 are not closed together, control returns to step 430, and the system waits for a new pinch multi-touch event to occur. On the other hand, If the user's two fingers 350 are closed together, then the two call sessions (represented by the third icon 310C and the fourth icon 320C) are removed from the smart phone display (step 460). Instead, the box 380 indicating that a conference call has been created appears. The third icon 310D, the fourth icon 320D, and the icon 370 representing the user (i.e. the conference call host) appear in the box 380 (step 470). The phone call is conferenced by the communication devices using telephonic techniques known in the art.

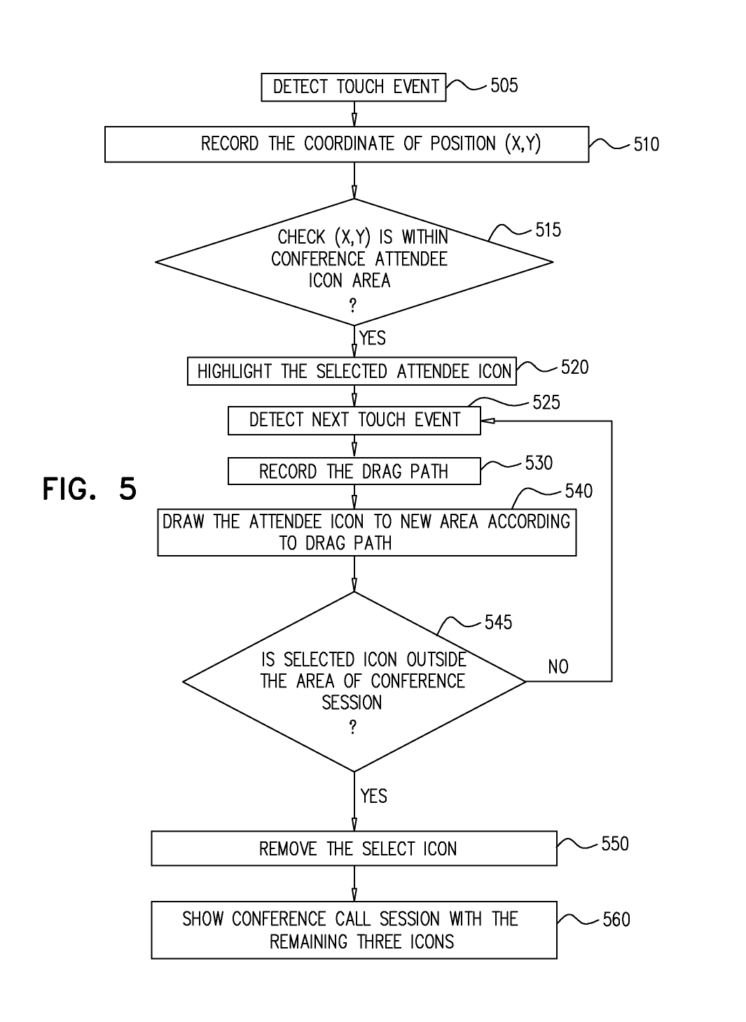

Reference is now additionally made to FIG. 5, which is a simplified flowchart diagram of a second method of operation of the embodiment of FIGS. 3A and 3B. FIG. 5 depicts the method of removing one of the merged calls from the merged conference call event, as shown in the final two stages of FIGS. 3A-B. In FIGS. 3A-B a scenario where three participants, Alice, Bob, and Carl, the user of the smart phone 300A-300F in the conference call, are shown. In FIG. 5, it is assumed that there are four parties participating in the conference call. Thus, when one of the merged calls is from the merged four party conference call event, the merged conference call event remains as a three party conference call event. If, however, there are only three participants in the merged conference call event, as depicted in FIGS. 3A-B, then the merged conference call event is terminated. This scenario can be extrapolated by persons of skill in the art based on the description previously provided.

A touch event is detected as having occurred on the touch screen user interface 345 of the smart phone 300A-300F (step 505). The touch screen user interface 345 relays the coordinates of (i.e.: X, Y) where the touch occurs to the processor (step 510). The processor in turn stores the coordinates in the memory. By way of example, in the fifth stage of FIGS. 3A-3B, one of the user's two fingers 350 first invokes a touch event (as in step 505) when it touches the third icon 310E on smart phone 300E. The coordinates where the one of the user's two fingers 350 is resting would be recorded in the memory in step 510.

A check is performed by the processor to determine if the coordinates (X, Y) where the touch event was detected is within the position of one of the icons 310E, 320E in the box 380 of the conference call session area (step 515). It is appreciated that a touch event which is not detected within the one of the icons 310E, 320E in the box 380 of the conference call session area produces no result in the context of the present embodiment (e.g., in FIGS. 3A-3B, the user's finger 350 may be below and to the right of the fourth icon 320E). If the touch event is determined in step 515 to be within the position of the one of the icons 310E, 320E in the box 380 of the conference call session area, then the selected one of the icons 310E, 320E is highlighted (step 520). By way of example, when the user's finger touches the fourth icon 320E, the smart phone 300E touch screen user interface 345 displays the fourth icon 320E as highlighted.

At this point, the touch screen user interface 345 detects a next touch event (step 525), in this case, a drag event. By way of example, in FIGS. 3A-3B, one of the user's two fingers 350 is shown on the smart phone 300E as having dragged (arrow 390) the fourth icon 320E from its previous location to be outside of the box 380 representing the conference call. In step 530 the touch screen user interface 345 relays the drag path to the processor. The processor in turn stores the drag path in the memory. It is appreciated that the drag path is, in fact, an ordered list of (X,Y) coordinates through which one of the user's two fingers 350 travels in dragging the fourth icon 320E outside of the box 380 representing the conference call.

A graphics processor (which may be one of the processors mentioned above) draws the fourth icon 320E on the portion of the touch screen to which the fourth icon 320E has been dragged (step 540). In FIGS. 3A-3B, for example, the fourth icon 320E is drawn by the graphics processor outside of the box 380 representing the conference call, as it is depicted on the smart phone 300E.

The processor determines if the selected call session (represented by the fourth icon 320E) has been dragged outside the area which represents the conference call, i.e. the box 380, or not (step 545). If the processor determines that the selected call session has not been dragged outside the area which represents the conference call, i.e. the box 380, then the method returns to step 525, and waits for a drag action, as described above. If, however, the processor determines that the selected call session has been dragged outside the area which represents the conference call, i.e. the box 380, then the processor will remove the selected call session represented by the fourth icon 320E (step 550).

The icons remaining in the box representing the conference call, for instance, the third icon 310F, the icon 370 representing the user (i.e. the conference call host), and an additional icon representing the fourth participant in the conference call still appear in the box 380 (step 560).

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A system comprising:
a user interface for a communication device, the user interface comprising:
a first icon representing a first communication event between a first party and a second party; and
a second icon representing a second communication event between the first party and a third party;
a processor to receive input signals from the first party, the input signals input via the user interface;
the processor, in response to the received input signals, performs one of:
a communication event transfer comprising transferring the first communication event from being between the first party and the second party to being between the second party and the third party; and
a communication event merger comprising the creation of a merged communication event between the user, the second party, and the third party.

2. The system according to claim 1 wherein, in the case of the communication event transfer, the received input signal comprises a drag and drop action, where one of the first icon and the second icon is dragged to and dropped on the other icon of the first icon and the second icon.

3. The system according to claim 1, in the case of the communication event transfer, and further comprising the processor being further operative to display a message on the user interface upon success of the transfer operation, indicating that the transfer succeeded.

4. The system according to claim 1 wherein, in the case of the communication event merger, the received input signal comprises a pinch gesture, the pinch gesture brings together the first icon and the second icon.

5. The system according to claim 4 wherein a partial overlap resulting from the pinch gesture results in the communication event merger.

6. The system according to claim 1 wherein, in the case of the communication event merger, the user interface displays the first icon and the second icon in a box representing the merged communication event.

7. The system according to claim 6 wherein dragging one of the first icon and the second icon outside the box representing the merged communication event removes the communication event represented by the dragged icon from the merged communication event.

8. The system according to claim 1 wherein, in the case of the communication event merger, a third icon representing a third communication event between a first party and a fourth party is added to the merged communication event.

9. The system according to claim 1 wherein the communication device comprises one of: a tablet device; a smartphone; a desktop computer; a portable computer; a set-top box; an Internet-enabled television; and a media center PC.

10. A user interface comprising:
a display element operative to render:
a first icon representing a first communication event between a first party and a second party; and
a second icon representing a second communication event between the first party and a third party;
a processor to receive input signals from the first party input via the user interface;
the processor, in response to the received input signals, performs one of:
a communication event transfer comprising transferring the first communication event from being between the user and the second party to being between the second party and the third party; and
a communication event merger comprising the creation of a merged communication event between the user, the second party, and the third party.

11. The user interface according to claim 10 wherein, in the case of the communication event transfer, the received input signal comprises a drag and drop action, where one of the first icon and the second icon is dragged to and dropped on the other icon of the first icon and the second icon.

12. The user interface according to claim 10, in the case of the communication event transfer, and further comprising the display element being further operative to render a message on the user interface upon success of the transfer operation, indicating that the transfer succeeded.

13. The user interface according to claim 10 wherein, in the case of the communication event merger, the received input signal comprises a pinch gesture, the pinch gesture brings together the first icon and the second icon.

14. The user interface according to claim 13 wherein a partial overlap resulting from the pinch gesture results in the communication event merger.

15. The user interface according to claim 10 wherein, in the case of the communication event merger, the user interface renders the first icon and the second icon in a box representing the merged communication event.

16. The user interface according to claim 15 wherein dragging one of the first icon and the second icon outside the box representing the merged communication event removes the communication event represented by the dragged icon from the merged communication event.

17. The user interface according to claim 10 wherein, in the case of the communication event merger, a third icon representing a third communication event between a first party and a fourth party is added to the merged communication event.

18. The user interface according to claim 10 wherein the communication device comprises one of: a tablet device; a smartphone; a desktop computer; a portable computer; a set-top box; an Internet-enabled television; and a media center PC.

19. A method comprising:
rendering a first icon and a second icon on a user interface for a communication device, the first icon representing a first communication event between a first party and a second party and the second icon representing a second communication event between the first party and a third party;
receiving input signals at a processor from the first party, the input signals input via the user interface;
performing, by the processor, in response to the received input signals, one of:
transferring the first communication event from being between the first party and the second party to being between the second party and the third party; and
creating a merged communication event between the user, the second party, and the third party.

20. The method according to claim 19 wherein the communication device comprises one of: a tablet device; a smartphone; a desktop computer; a portable computer; a set-top box; an Internet-enabled television; and a media center PC.
